(19) United States
(12) Patent Application Publication
(10) Pub. No.: US 2007/0243039 A1
(43) Pub. Date: Oct. 18, 2007

(54) Cage nut assembly

(76) Inventors: Lawrence W. Johnson, Taylor, MI (US); Brian M. Parisi, Macomb, MI (US); Allan F. Anthony, St. Clair, MI (US); Anthony Pascariello, Southington, CT (US); William J. Curley, Waterbury, CT (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/595,587

(22) Filed: Nov. 9, 2006

Related U.S. Application Data
(60) Provisional application No. 60/787,006, filed on Mar. 29, 2006.

(51) Int. Cl. F16B 39/284

(52) U.S. Cl. 411/111

(57) ABSTRACT

Embodiments of the present invention provide a cage nut assembly that includes a cage and a securing body, which may be part of a structure that is to be secured to another structure. The cage includes a base and lateral walls folded over an internal chamber. The base includes a plurality of fastener openings formed therethrough. The securing body includes a plurality of draw nuts having fastener passages formed therethrough, wherein the fastener passages are aligned with the fastener

### RELATED APPLICATIONS

This application relates to and claims priority benefits from U.S. Provisional Patent Application Ser. No. 60/787,006 entitled “Cage Nut Assembly,” filed Mar. 29, 2006, which is hereby incorporated by reference in its entirety.

### FIELD OF THE INVENTION

Embodiments of the present invention generally relate to a fastener assembly, and more particularly to a cage nut assembly.

### BACKGROUND OF THE INVENTION

Various items may be secured to one another through a plurality of bolt and nut combinations. Additionally, cage nuts of varying shapes and sizes are adapted for mating cooperation with suitable bolts.

Use of a cage nut eliminates the need for a separate nut. In many applications, a cage nut is welded to one component, and then a bolt threadably engages the cage nut secures another component to the first component.

Typically, if multiple bolts are used to secure one component to another, multiple cage nuts are used. That is, each bolt threadably engages a separate cage nut. Moreover, if the cage nut is welded to a component, each cage nut is usually welded at two separate points to the component. Thus, if two bolts are used to secure a component together, two separate cage nuts are welded to one of the components at four weld points (i.e., two weld points for each cage nut).

Thus, a need exists for a cage nut assembly that may receive and retain multiple bolts or other such fasteners.

### SUMMARY OF THE INVENTION

Certain embodiments of the present invention provide a cage nut assembly configured to securely retain a first structure to a second structure. The assembly comprises a cage and a securing body.

The cage includes a base and lateral walls folded over an internal chamber. The base includes two fastener openings formed therethrough. The cage is configured to be welded to the first structure.

The securing body may be part of the second structure and is retained within the internal chamber. The securing body includes two draw nuts having fastener passages formed therethrough. The fastener passages are aligned with the fastener openings.

The cage may also include a cavity or cut-out area defined by internal edges of the folded over lateral walls. The draw nuts extend through the cut-out area, wherein the cut-out area allows the securing body to move through a limited range of motion relative to the cage.

The base of the cage may also include a plurality of lift tabs around a periphery of each of the fastener openings. The lift tabs extend into the internal chamber, and support the securing body above the base.

### DESCRIPTION OF SEVERAL VIEWS OF THE DRAWINGS

FIG. 1 illustrates an isometric top view of a cage nut assembly according to an embodiment of the present invention.

FIG. 2 illustrates an isometric bottom view of a cage nut assembly according to an embodiment of the present invention.

FIG. 3 illustrates a lateral cross-sectional view of a cage nut assembly according to an embodiment of the present invention.

FIG. 4 illustrates an isometric view of a cage nut assembly mounted on a structure according to an embodiment of the present invention.

FIG. 5 illustrates an isometric view of a cage nut assembly secured to a structure through a bolt according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

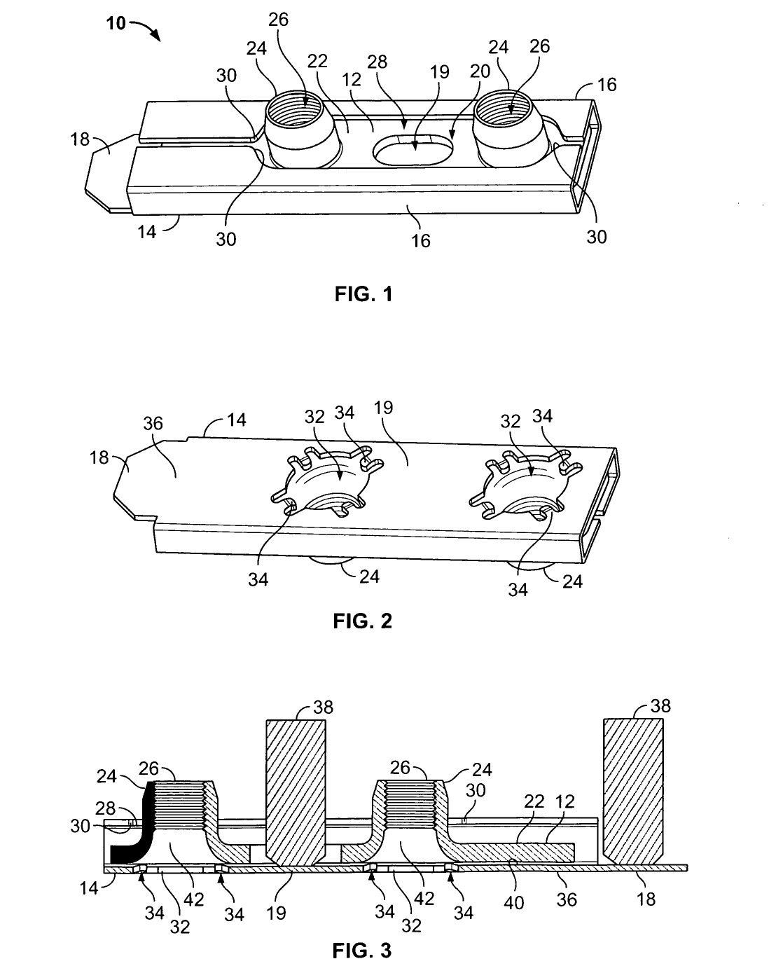

FIG. 1 illustrates an isometric top view of a cage nut assembly 10 according to an embodiment of the present invention. The cage nut assembly 10 includes a securing body 12 positioned within a cage 14. The securing body 12 may be a portion of a component that is to be secured to another component. For example, the securing body 12 may be part of a mounting stud of a vehicle transmission assembly.

In order to secure the securing body 12 within the cage 14, the cage 14 may initially be a flat piece of material, such as a metal. The securing body 12 is then positioned over the flat cage 14. Lateral portions 16 of the cage 14 are then bent, rolled or folded over lateral edges (not shown) of the securing body 12 to trap the securing body 12 within an interior chamber of the cage 14.

The cage 14 includes two weld spots 18 and 19; however, more or less weld spots than those shown may be used. One weld spot 18 is at a distal end of the cage 14, while the other weld spot 19 is proximate the center of the cage 14. When the cage 14 is a flat piece of material, the securing body 12 may be positioned over the cage 14 such that a central opening 20 of the securing body 12 is aligned over the central weld spot 19 (and fastener passages of the securing body 12 are aligned over fastener openings of the cage 14). The alignment of the opening 20 over the central weld spot 19 indicates that the securing body 12 is properly aligned with respect to the cage 14. Thus, the lateral portions 16 may be folded over the lateral edges of the securing body 12. The cage 14 may be welded or fixed to a structure through the weld spots 18 and 19 before or after the lateral portions 16 are folded over the lateral edges of the securing body 12.

While the weld spot 19 and the central opening 20 may be used to align the securing body 12 with respect to the cage 14, the central opening 20 may merely be an opening that allows passage of a weld electrode. In this case, the securing body 12 is aligned with respect to the cage 14 by aligning fastener passages or through holes of the securing body 12 with similar features of the cage 14.

The securing body 12 includes a planar base 22 having a plurality of fastener receiving draw nuts 24 extending upwardly therefrom. As shown in FIG. 1, the securing body 12 includes two draw nuts 24. Alternatively, the securing body 12 may including more draw nuts 24 than those shown.

Each draw nut 24 includes a fastener passage 26 formed therethrough. The fastener passage 26 may be threaded to reciprocally mate with a threaded surface of a fastener such as a bolt or screw. The fastener passages 26 are aligned with fastener openings (not shown in FIG. 1) formed through the cage 14. Thus, fasteners (not shown) may pass through the fastener passages 26 and the fastener openings.

A central cavity 28 or cut-out is formed through a top surface of the cage 14. The central cavity 28 allows the securing body 12 to move or float within the cage a limited amount. That is, internal edges 30 of the cage 14 that define the central cavity 28 form a barrier that the draw nuts 24 abut against if the securing body 12 moves too far. In any event, the central cavity 28 ensures that the fastener passages 26 remain aligned over the fastener openings of the cage 14, but, at the same time, allow the securing body 12 to move a limited amount in order to allow fasteners to easily pass through the cage nut assembly 10. That is, the periphery of the cavity 28 defined by the internal edges 30 of the cage 14 controls the float of the securing body 12 to accommodate possible misalignment during a securing operation. Misalignment may occur when two separately made components are assembled due to the fact that there may be tolerance deviations between the components.

FIG. 2 illustrates an isometric bottom view of the cage nut assembly 10. As shown in FIG. 2, fastener openings 32 are formed through the cage 14 and are aligned with the fastener passages 26 (shown in FIG. 1) of the draw nuts 24. Lift tabs 34 are positioned around the periphery of the fastener passages 26. The lift tabs 34 are configured to lift the securing body 12 above a base 36 of the cage 14. The lift tabs 34 of the cage 14 ensure that the securing body 12 contacts the cage 14 at minimal points, before fasteners are secured through the cage nut assembly 10. The minimal surface contact between the underside of the planar base 22 (shown in FIG. 1) of the securing body 12 and the top surface of the base 36 of the cage 14 prevents the securing body 12 from sticking to the cage 14 during a manufacturing process such as a vehicle e-coat process. Thus, the securing body 12, including the draw nuts 24, is still allowed to float or move within the cage 14 (limited by the edges 30) after the manufacturing process.

FIG. 3 illustrates a lateral cross-sectional view of the cage nut assembly 10. Weld electrodes 38 contact the cage 14 at the weld points 18 and 19 to weld the cage 14 to a structure, such as a vehicle frame or other such structure. The weld points 18 and 19 are easily accessible by the weld electrodes 38. The lift tabs 34 lift the securing body 12 above the top surface 40 of the base 36 of the cage 14.

As shown in FIG. 3, the diameter 42 of each fastener passage 26 is larger than the diameter of each fastener opening 32. The larger diameters 42 of the fastener passages 26 allow bolts to be guided into the threadable interfaces of the fastener openings 32, thereby eliminating cross-threading issues. As discussed above, the edges 30 of the cage 14 control the float of the securing body 12 to accommodate possible misalignment.

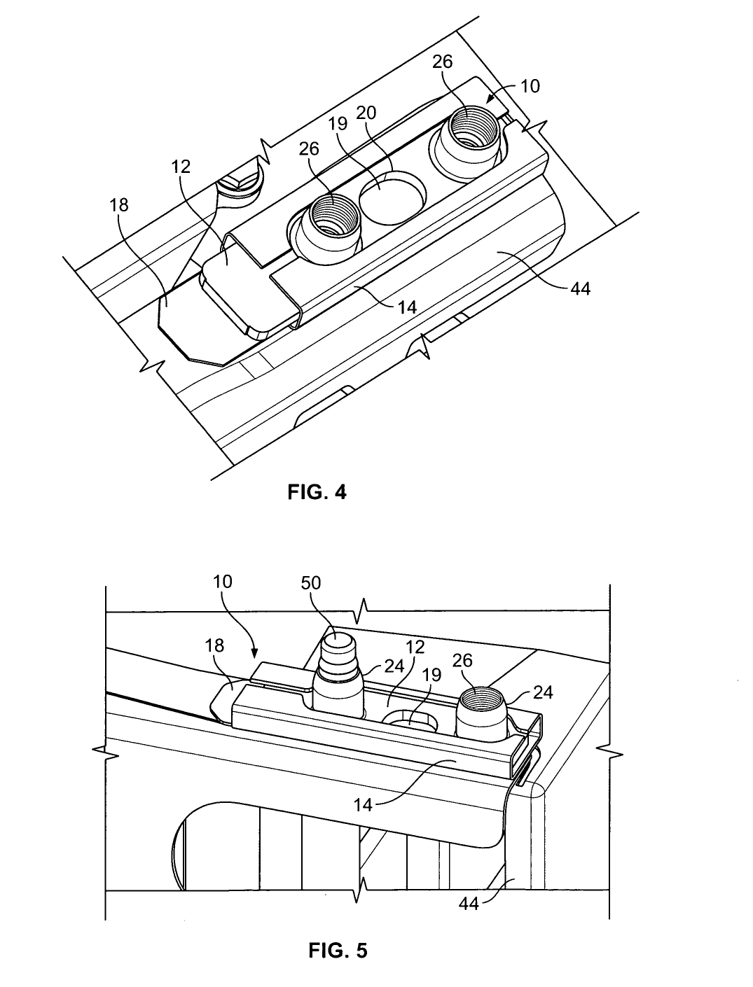

FIG. 4 illustrates an isometric view of the cage nut assembly 10 mounted on a structure 44 according to an embodiment of the present invention. The structure 44 may be an engine support frame, a transmission assembly body, or the like. As discussed above, the cage 14 is welded to the structure through the weld points 18 and 19. Once the cage nut assembly 10 is welded to the structure 44, bolts may be passed through the fastener passages 26 of the securing body 12 and the fastener openings (shown in FIGS. 2 and 3) of the cage 14 to secure another component to the structure. For example, the securing body 12 may be a securing member of a second component, such as a transmission assembly, that is to be secured to the structural frame 44 within a vehicle.

FIG. 5 illustrates an isometric view of the cage nut assembly secured to the structure 44 through a bolt 50 according to an embodiment of the present invention. The bolt 50 is threaded into the fastener passage 26 of the draw nut 24. The bolt 50 threadably engages the fastener passage 26 of the securing body 12 and the fastener opening (not shown in FIG. 5) of the cage 14 to securely fasten the structure 44 to another component, which may be integrally connected to the securing body 12. As shown in FIG. 5, the cage nut assembly 10 is configured to receive and retain two bolts 50. Although, as mentioned above, the cage nut assembly 10 may be designed and configured to provide additional draw nuts 24.

In one particular application, the cage 14 may be mounted to a vehicle structure so that a transmission can be attached to the vehicle structure through bolts threadably securing to the cage 14. Embodiments of the present invention can be used, however, in numerous applications and the automobile application is merely one example.

Thus, embodiments of the present invention provide a cage nut assembly that accommodates multiple bolts or other such fasteners. Multiple bolts may be used with the cage nut assembly while the cage itself is welded at a minimum of points to a particular structure.

While various spatial terms, such as upper, bottom, lower, mid, lateral, horizontal, vertical, and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A cage nut assembly comprising:
a cage comprising a base and lateral walls folded over an internal chamber, said base having a plurality of fastener openings formed therethrough; and
a securing body retained within said internal chamber, said securing body comprising a plurality of draw nuts having fastener passages formed therethrough, wherein said fastener passages are aligned with said fastener openings.

2. The cage nut assembly of claim 1, wherein said cage further comprises a cut-out area defined by internal edges, said plurality of draw nuts extending through said cut-out area, wherein said cut-out area allows said securing body to move through a limited range of motion relative to said cage.

3. The cage nut assembly of claim 1, wherein said base further comprises at least one weld spot configured to be welded to a structure.

4. The cage nut assembly of claim 1, further comprising a plurality of lift tabs around a periphery of each of said fastener openings, said plurality of lift tabs extending into said internal chamber, said plurality of lift tabs supporting said securing body above said base.

5. The cage nut assembly of claim 1, wherein said plurality of draw nuts comprises two draw nuts.

6. The cage nut assembly of claim 1, wherein a first diameter of each of said fastener passages is greater than a second diameter of each of said fastener openings.

7. The cage nut assembly of claim 1, wherein each of said fastener passages and each of said fastener openings are threaded.

8. The cage nut assembly of claim 1, wherein each of said fastener passages and each of said fastener openings are configured to threadably retain a threaded bolt.

9. A cage nut assembly configured to securely retain a first structure to a second structure, the cage nut assembly comprising:
a cage comprising a base and lateral walls folded over an internal chamber, said base having two fastener openings formed therethrough, said cage being welded to the first structure; and
a securing body of the second structure retained within said internal chamber, said securing body comprising two draw nuts having fastener passages formed therethrough, wherein said fastener passages are aligned with said fastener openings.

10. The cage nut assembly of claim 9, wherein said cage further comprises a cut-out area defined by internal edges, said draw nuts extending through said cut-out area, wherein said cut-out area allows said securing body to move through a limited range of motion relative to said cage.

11. The cage nut assembly of claim 9, wherein said base further comprises two weld spots configured to be welded to the first structure.

12. The cage nut assembly of claim 9, further comprising a plurality of lift tabs around a periphery of each of said fastener openings, said plurality of lift tabs extending into said internal chamber, said plurality of lift tabs supporting said securing body above said base.

13. The cage nut assembly of claim 9, wherein a first diameter of each of said fastener passages is greater than a second diameter of each of said fastener openings.

14. The cage nut assembly of claim 9, wherein each of said fastener passages and each of said fastener openings are threaded.

15. The cage nut assembly of claim 9, wherein each of said fastener passages and each of said fastener openings are configured to threadably retain a threaded bolt.

16. A cage nut assembly configured to securely retain a first structure to a second structure, the cage nut assembly comprising:
a cage comprising a (i) base integrally formed with lateral walls folded over an internal chamber, (ii) weld spots configured to allow said cage to be welded to a structure, and (iii) a cut-out area defined by internal edges of said lateral walls, said base having two fastener openings formed therethrough; and
a securing body retained within said internal chamber, said securing body comprising (i) two draw nuts having fastener passages formed therethrough, and (ii) a plurality of lift tabs around a periphery of each of said fastener openings, said plurality of lift tabs extending into said internal chamber, said plurality of lift tabs supporting said securing body above said base, said fastener passages being aligned with said fastener openings, said plurality of draw nuts extending through said cut-out area, wherein said cut-out area allows said securing body to move through a limited range of motion relative to said cage.

17. The cage nut assembly of claim 16, wherein a first diameter of each of said fastener passages is greater than a second diameter of each of said fastener openings.

18. The cage nut assembly of claim 16, wherein each of said fastener passages and each of said fastener openings are threaded.

19. The cage nut assembly of claim 16, wherein each of said fastener passages and each of said fastener openings are configured to threadably retain a threaded bolt.
